(19) United States
(12) Patent Application Publication
(10) Pub. No.: US 2008/0147457 A1
(43) Pub. Date: Jun. 19, 2008

(54) Systems and methods for handling attributes used for assignment generation in a value flow environment

(76) Inventor: Roman A. Rapp, Villeneuve Loubet (FR)

Correspondence Address: SAP / FINNEGAN, HENDERSON LLP, 901 NEW YORK AVENUE, NW, WASHINGTON, DC, 20001-4413, US

(21) Appl. No.: 11/657,017

(22) Filed: Jan. 24, 2007

(30) Foreign Application Priority Data
Dec. 15, 2006 (EP) 06291975.8

(51) Int. Cl. G06F 9/44

(52) U.S. Cl. 705/7

(57) ABSTRACT

Systems and methods are provided for handling data to generate an assignment between a base business object and a partner business object in a value flow environment. In one implementation, a function of an assignment creation definition is read to identify an attribute of the base business object, a value of the attribute being required for evaluation of the function. Further, it is determined whether the value of the attribute is stored in a main memory and, if the value of the attribute is stored in the main memory, then the value is retrieved from the main memory. If the value of the attribute is not stored in the main memory, then the value is retrieved from a database. Thereafter, the function is evaluated based on the retrieved value of the attribute to generate the assignment.

### TECHNICAL FIELD

The present invention generally relates to systems and methods for analyzing flows of values, such as values of raw materials, products, parts, or personnel. More particularly, the invention relates to systems and methods for handling attributes that are used to generate assignments describing attributes of business-related activities involving value flows.

### BACKGROUND INFORMATION

Businesses analyze and control the use of values of resources, money, or other items by business-related activities to achieve desirable levels of performance. Such an analysis may involve measuring, evaluating, and optimizing these activities to streamline costs or other expenditures of the values. For example, a company can identify factors contributing to loss of revenue and modify its deployment of the values to mitigate the revenue loss. Modeling and analyzing the costs associated with a set of business-related activities, such as designing and manufacturing a product, may be a critical aspect of bringing that product to market. The same can also be said for designing and offering a service.

To evaluate value flows, businesses can use computer-implemented modeling systems that simulate business-related entities that provide or consume the values, and determine attributes of value flows among these entities. By using such a modeling system, a business can simulate, for example, the expected costs associated with the value flows when the activities are performed. The business is thereby able to anticipate and plan for the costs throughout all phases of design and production. In addition, by simulating expected value expenditures, it is possible to vary and control actual value expenditures, such as the cost of materials or labor. For example, by varying the choice of materials, a business can determine the effect of substituting one material for another.

Modeling systems may simulate the business-related entities as business objects that have attributes. These business objects may be stored in databases, such as non-volatile databases, for retrieval by a modeling system when the business objects are later referenced. In order for applications of the modeling system to evaluate the attributes of the value flows among the business-related entities, the modeling system may retrieve the attributes of the business-related entities from the databases and store these attributes into a main memory, such as a volatile memory. The modeling system then evaluates the attributes of the business-related entities to evaluate the attributes of the value flows. However, repeatedly retrieving the attributes of the business-related entities from the databases may consume an undesirably large amount of time.

Furthermore, modeling systems may only be able to retain a limited amount of attribute data in the main memory. The hardware implementing the main memory may have physical characteristics that constrain the storage capacity of the main memory in comparison to the databases. For example, the main memory may be adapted for high-speed retrieval at the expense of storage capacity, while the databases may be adapted for high storage capacity at the expense of retrieval speed. The limited storage capacity of the main memory may make a modeling system undesirably reliant on repeated retrieval of attribute data from the databases.

Thus, it is desirable to have systems and methods for increasing the speed of evaluating attributes of value flows. It is further desirable to have systems and methods for efficiently using memory when evaluating the attributes of the value flows.

### SUMMARY

Consistent with embodiments of the invention, systems and methods are provided for handling attributes of business objects to evaluate attributes of value flows among the business objects. Embodiments of the invention may increase the speed with which the attributes of the value flows are evaluated and improve the efficiency of memory use. Embodiments of the invention include computer-implemented systems and methods, as well as computer readable media including instructions that perform methods consistent with the invention when implemented by a computer or processor.

In accordance with one embodiment, a method is provided of handling attributes to generate an assignment between a base business object and a partner business object in a value flow environment. The method may comprise reading a function of an assignment creation definition to identify an attribute of the base business object, a value of the attribute being required for evaluation of the function. According to the method, it is determined whether the value of the attribute is stored in a main memory. If the value of the attribute is stored in the main memory, then the value is retrieved from the main memory. If the value of the attribute is not stored in the main memory, then the value is retrieved from a database. Further, the function is evaluated based on the retrieved value of the attribute to generate the assignment.

In accordance with another embodiment, a system is provided for handling attributes to generate an assignment between a base business object and a partner business object in a value flow environment. The system may comprise a main memory, a database, and an evaluator. The evaluator may read a function of an assignment creation definition to identify an attribute of the base business object, a value of the attribute being required for evaluation of the function. Further, the evaluator may determine whether the value of the attribute is stored in the main memory. If the value of the attribute is stored in the main memory, then the evaluator retrieves the value from the main memory. If the value of the attribute is not stored in the main memory, then the evaluator retrieves the value from the database. In addition, the evaluator may evaluate the function based on the retrieved value of the attribute to generate the assignment.

In accordance with yet another embodiment, a computer-readable medium is provided that comprises programmable instructions adapted to perform a method of handling attributes to generate an assignment between a base business object and a partner business object in a value flow environment. The method may comprise reading a function of an assignment creation definition to identify an attribute of the base business object, a value of the attribute being required for evaluation of the function. According to the method, it is determined whether the value of the attribute is stored in a main memory. If the value of the attribute is stored in the first memory, then the value is retrieved from the main memory. If the value of the attribute is not stored in the first memory, then the value is retrieved from a database. Further, the function is evaluated based on the retrieved value of the attribute to generate the assignment.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments consistent with the present invention may be directed to various combinations and sub-combinations of the features described in the following detailed description.

### BRIEF DESCRIPTION OF THE DRAWINGS

The accompanying drawings, which are incorporated in and constitute a part of this specification, illustrate embodiments of the invention and, together with the description, serve to explain advantages and principles of the invention. In the drawings:

FIG. 1 is a schematic diagram of an exemplary embodiment, consistent with the present invention, of an application platform;

FIG. 2 is a schematic diagram of an exemplary embodiment, consistent with the present invention, of a value flow environment containing a base business object, a partner business object, and an assignment between the base business object and the partner business object;

FIG. 3 is a flowchart of an exemplary embodiment, consistent with the present invention, of a method of creating, deriving, and evaluating an assignment creation definition to generate assignments;

FIG. 4 is a flowchart of an exemplary embodiment, consistent with the present invention, of a method of retrieving a value of an attribute that is requested by a function of an assignment creation definition; and

FIG. 5 is a schematic diagram of an exemplary embodiment, consistent with the present invention, of a computer that includes a computer-readable medium having programmable instructions to retrieve values of attribute and generate assignments based on the retrieved attribute values.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Consistent with the present invention, an application platform can provide a foundation for modeling, analyzing, and controlling flows of values among business objects. The values may include values of, for example, raw material, products, parts, or personnel. Business objects may comprise data structures that represent providers or consumers of values, such as activities involving those values. Each of the data structures may comprise a data container that organizes related items of information as a plurality of “attributes” that may have individual values. For example, the data structure may be organized as a hierarchical tree having the attributes at nodes of the tree. In one embodiment, the application platform can universally model all phases of, for example, designing and producing a product or service, ranging from standard cost estimates and cost center accounting, such as planning and simulation, through product cost by order or period, such cost object controlling and profitability. Further, users may create new specialized applications without having to use a conventional programming language.

In accordance with one embodiment, by using the application platform, a user may simulate any activity, such as activities that occur in a life cycle of creating and producing a new product or service. For example, when developing a new product, an individual or group may initially have a design concept. This first step involves developing the initial design concept to the point that the product is defined in at least a rudimentary fashion. The next step may be to refine the design concept, which is done in a detailed design phase. During the detailed design phase, the specifics of the desired product are determined. This may include deciding not only the specifications of the product, such as size, shape, and components, but also selecting the particular materials or parts that will be used to create the product. The next step is to establish the supply chain, which refers to distributors that a business will use to obtain materials for the product, as well as the process that the business will use to actually create the product. This may involve, for example, creating assembly lines for large products and selecting workers to assemble products. Actual production of the product follows, which includes creating the product and bringing it to market for the lifetime of the product. Other costs may occur after and during this production phase, such as maintenance and service of machines that carry out the production process.

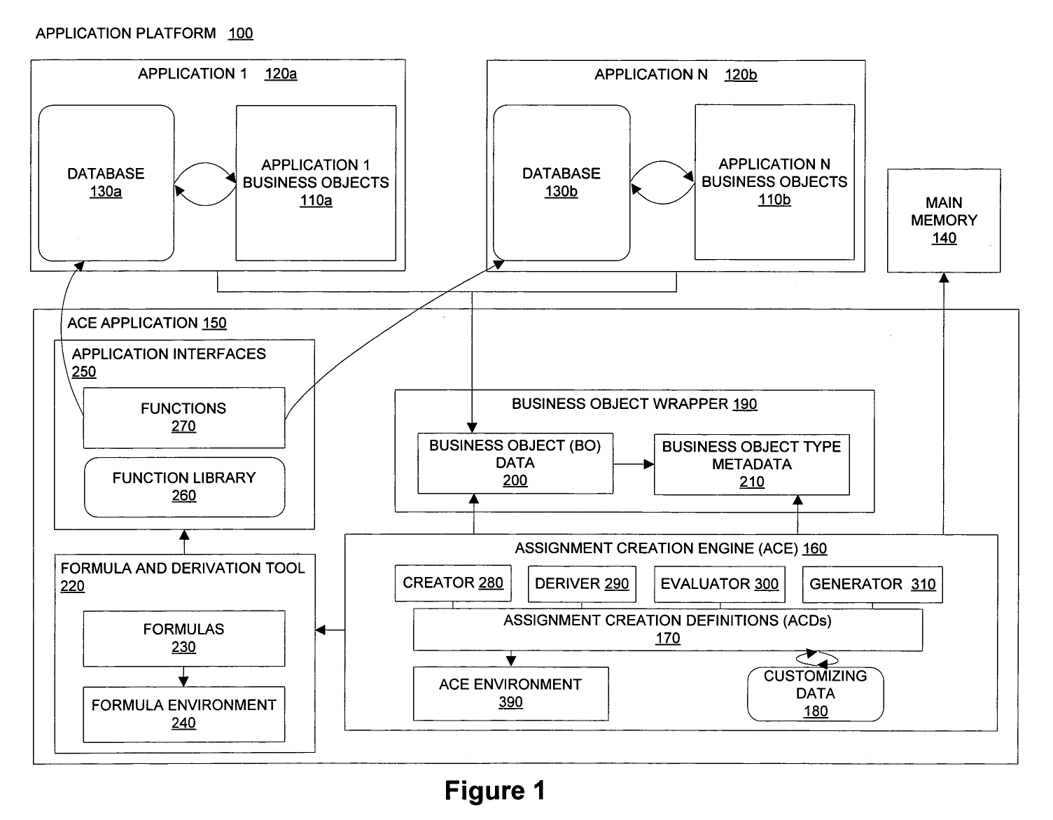

FIG. 1 is a block diagram of an exemplary embodiment, consistent with the present invention, of an application platform 100. In order to provide a universal foundation to meet the requirements of a flexible and adaptable value flow model, application platform 100 may create a value flow environment. The value flow environment may be implemented as a virtual environment that contains one or more elements, such as business objects (BOs) 110a, 110b, assignments between BOs 110a, 110b, and other data structures. The value flow environment may further comprise applications 120a, 120b that operate on BOs 110a, 110b, respectively, such as by using or modifying BOs 110a, 110b. In addition, the value flow environment may include functions and/or formulas.

Application platform 100 may use metadata to define BO types, assignment types, and/or the tables in the value flow environment. As will be appreciated by those skilled in the art, metadata is data that describes other data. For example, metadata may describe how, when, and by whom a particular set of data was collected, as well as how the data are formatted. Individual instances of the BOs 110a, 110b and assignments can each be associated with attributes. The attributes may be freely defined or can be selected at the time of configuration from data elements stored in a database. Each of the attributes may have one or more values, such as characteristics, key figures (i.e., numerical values), or other values.

The attributes of BOs 110a, 110b may include master data and/or transactional data. The master data is essential data that is related to its associated BO. The master data may include, for example, a production order identification or a description of produced materials. The transactional data, on the other hand, may include periodic data related to the operation of one of applications 120a, 120b on the BO that is associated with the transactional data. The transactional data may include, for example, a confirmation that specified steps have been performed.

The attributes of BOs 110a, 110b, such as the master data and/or transactional data, may be stored in one or more databases 130a, 130b that can be accessed by application platform 100. Databases 130a, 130b may be relational databases, such as Structured Query Language (SQL) databases. Examples include, but are not limited to, an Oracle® relational database management system, a Microsoft® SQL Server, and Sybase®. Each of the relational databases contains one or more sets of data elements, each of the data elements being a value of one of the attributes. The different sets may have the same sets of attributes. The sets of data elements may together be referred to as a “table.” For example, an SQL database may contain sets of ordered data elements, wherein the data elements are ordered by attribute within each of the sets.

Databases 130a, 130b may be implemented in a physical memory that is adapted to have substantially high storage capacity. Databases 130a, 130b may also be adapted to have substantially long-term storage permanence. For example, databases 130a, 130b may be implemented in a non-volatile memory. Databases 130a, 130b may be implemented in one or more of a magnetic hard drive, an optical disc, a magneto-optical hard drive, a magnetic tape, a Flash memory, and a solid-state read-only memory (ROM).

Application platform 100 may also access a main memory 140 that supports the operations performed on BOs 110a, 110b. Main memory 140 may also be referred to as a “primary memory.” Values of selected attributes of BOs 110a, 110b, such as selections of master and/or transactional data, may be retrieved from databases 130a, 130b and temporarily stored in main memory 140. Application platform 100 can then access main memory 140 to perform the desired operations on BOs 110a, 110b.

Main memory 140 may be adapted to have a data retrieval speed that is greater than a data retrieval speed of databases 130a, 130b. The greater retrieval speed may include one or more of a lesser access time and a greater data transfer rate. Main memory 140 may be implemented in a random-access memory (RAM), such as a volatile or non-volatile RAM. For example, main memory 140 may be implemented in one or more of a solid-state memory, a magnetic hard drive, and a rewritable optical disc.

Application platform 100 may comprise an assignment creation engine (ACE) application 150 to instantiate an assignment creation engine 160 that manages the generation of the assignments for BOs 110a, 110b. The assignments may also be referred to as “edges.” Each of the assignments is a directed link from a first BO, referred to as the sender BO, to a second BO, referred to as the receiver BO. The sender BO may be a provider of a value and the receiver BO may be a consumer of the value, such that there is a flow of the value from the sender BO to the receiver BO. The value may be a value of, for example, money or resources such as materials, parts, or labor. The sender BO may be, for example, a cost center or project. The receiver BO may be, for example, a production order.

The assignment may include one or more attributes, such as characteristics or key figures, that describe the value flow. In one example, the sender BO is a cost center or project, and the receiver BO is a production order. In this example, one of applications 120a, 120b triggers assignment creation engine 160 to create an assignment between the sender BO and the receiver BO to contain a calculated overhead surcharge associated with the flow of a quantity of material from the cost center or project to the production order.

Assignment creation engine 160 is used to create, assign, and evaluate assignment creation definitions (ACDs) 170 that define how the assignments are to be automatically generated. Exemplary embodiments of assignment creation engine 160 are further described in U.S. patent application Ser. No. 11/495,571, filed Jul. 31, 2006, and entitled “Systems and Methods for Assignment Generation in a Value Flow Environment,” the disclosure of which is expressly incorporated herein in its entirety. Individual ACDs 170 may comprise a series of lines, each of which can be executed when ACD 170 is evaluated. Each of the lines may include a plurality of columns that define cells of the line. ACDs 170 may refer to customizing data 180 to further adapt ACDs 170 to particular applications.

When one of applications 120a, 120b is executed, that application can trigger assignment creation engine 160 to assign ACDs 170 to one or more instances of BOs 110a, 110b selected by the application, and evaluate the assigned ACDs for those instances of BOs 110a, 110b. ACDs 170 can be evaluated based on the attributes of BOs 110a, 110b. Application platform 100 may also include a BO wrapper 190 to interface between assignment creation engine 160 and BOs 110a, 110b. The BO wrapper 180 can contain data 200 about BOs 110a, 110b and metadata 210 about BO types to facilitate exchange of information between assignment creation engine 160 and BOs 110a, 110b.

ACE application 150 may further comprise a formula and derivation tool 220 to manage formulas 230. Formulas 230 may comprise, for example, formulas, rules, or instructions. Formulas 230 may be executed by applications 120a, 120b or assignment creation engine 160. For example, formulas 230 may include the formulas used by ACDs 170 to determine partner BOs in relation to base BOs. Formula and derivation tool 220 may instantiate a formula environment 240 to define formulas 230. Formula environment 240 may have a user interface, such as a GUI, through which an operator, such as a human operator, can enter formulas 230. In addition, ACE application 150 may include one or more application interfaces 250, such as a function library 260 to store functions 270 that can operate on the attributes of BOs 110a, 110b. These functions may include, for example, algorithms, formulas, rules, pointers, or other functions.

Assignment creation engine 160 may include a creator 280 to create one or more of ACDs 170, each of which comprises executable “lines” that generate assignments upon execution. For example, an operator, such as a human operator using a GUI, may use assignment creation engine 160 to construct an ACD that will generate assignments containing desired attributes whose values are evaluated at the time of execution. The lines may have multiple columns that define a plurality of cells for each of the lines. The lines and columns of the ACD may together be referred to as a “template.” For example, each of the lines of ACDs 170 may identify a partner BO and specify functions used to generate the attributes.

The lines of the ACD may include an “Object” column that refers to the partner objects to which the generated assignments will relate. The Object cell of the line may contain a unique identifier (ID) that is a static ID, such as a project ID, or a formula that is to be evaluated to identify the partner object for that line. For example, the formula may be one of formulas 230 managed by formula and derivation tool 220.

The lines may also include one or more “Attribute” columns. Each of the Attribute cells of each of the lines may contain a function that can be evaluated to determine a value of a corresponding attribute of a corresponding one of the generated assignments. The functions may be expressed in an abstract form that takes attributes of the base BOs and/or partner BOs as parameters. For example, the functions may be functions 270 in function library 260. When the ACD has multiple lines, then the Attribute column may have a plurality of functions that are arranged to be computed sequentially. For example, the Attribute columns may include one or more “Characteristics” columns that contain characteristics and/or “Key Figures” columns that contain key figures. Certain functions may retrieve values from other cells, specified by line and column, of the ACD.

In addition, assignment creation engine 160 may comprise a deriver 290 to assign one of ACDs 170 to each of the base BOs, which may be a sender BO or receiver BO. The process of assigning ACDs 170 may also be referred to as “derivation.” The appropriate ACD to assign may be identified based on the type of application 120a, 120b that triggered assignment creation engine 160. Upon execution, one of applications 120a, 120b selects the base BO as needing an assignment to a partner BO. Applications 120a, 120b may also pass an identifier of the selected base BO to assignment creation engine 160, which uses rules to identify one or more of ACDs 170 that are to be assigned to the base BO based on the attributes of the base BO. These rules may comprise rules and/or filters. A plurality of rules may be defined in relation to a single base BO. For example, each of the rules may be adapted to operate on a base BO that has a particular BO type. Furthermore, each of the rules can use one or more of the attributes of the base BO to assign a particular one of ACDs 170 to that base BO.

Deriver 290 may further identify the appropriate ACD to assign based on a directionality of the assignments to be generated. Each of ACDs 170 can be characterized as either sender-based or receiver-based, meaning that the base BO from which each of the particular ACDs 170 is assigned is either a sender BO or a receiver BO, respectively. Deriver 290 determines whether the base BO is a sender BO or a receiver BO. If the base BO is a sender BO, then deriver 290 assigns a sender-based ACD. If the base BO is a receiver BO, then deriver 290 assigns a receiver-based ACD. Correspondingly, for a sender-based ACD, the partner BO is a receiver BO; for a receiver-based ACD, the partner BO is a sender BO.

Assignment creation engine 160 may further include an evaluator 300 to evaluate the ACD on a line-by-line basis. For example, assignment creation engine 160 may sequentially read the lines of the ACD, such as from top to bottom, and execute each of the lines. Evaluator 300 may evaluate the ACD to determine the partner BOs, as described above. For example, the partner BOs may be determined based on the identifiers or formulas in the Object cells.

Evaluator 300 may also evaluate the functions in the Attribute cells to determine the values of the attributes that will be associated with the generated assignments. These attribute values may be stored in an internal result table before being associated with the assignments that are to be generated between the base BOs and the partner BOs. Assignment creation engine 160, using the ACD, may evaluate the functions based on the values of the attributes of the base BOs and/or the attributes of the partner BOs to determine the values of the attributes of the relevant assignments that are to be generated. For example, the formulas may be evaluated to calculate the values of characteristics and key figures. One or more of the functions in the ACD may refer to other data structures of the value flow environment, such as numerical constants, to retrieve data.

Assignment creation engine 160 may further include a generator 310 to generate the assignments between the base BO and each of the partner BOs determined by evaluator 300. For example, the individual lines may be designated as either generation lines, which generate directly-corresponding assignments upon execution, or non-generation lines, which do not generate directly-corresponding assignments upon execution. Each of the generated assignments has the attributes whose values have been determined by evaluator 300. Assignment creation engine 160 may also return the attribute values to whichever of applications 110a, 110b that triggered assignment creation engine 160, such as for further processing by those applications.

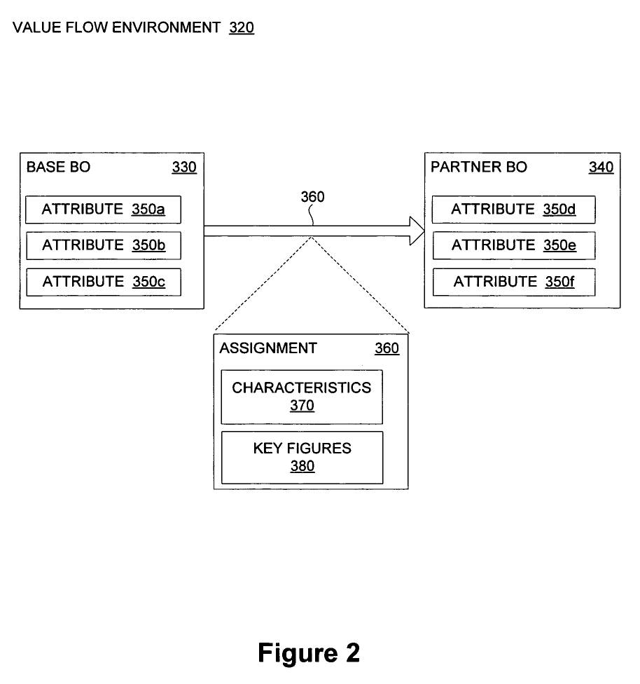

FIG. 2 is a schematic diagram, consistent with the present invention, of a portion of an exemplary embodiment of the value flow environment, shown as value flow environment 320. A base BO 330 and a partner BO 340 each comprise attributes 350a-350c and 350d-350f. Assignment 360, represented as an arrow in FIG. 2, is generated between base BO 330 and partner BO 340. In the example shown, base BO 330 is a sender BO and partner BO 340 is a receiver BO, as indicated by the directionality of the arrow representing assignment 360.

Exemplary data structures of assignment 360, base BO 330, and partner BO 340 are shown in part. In the example of FIG. 2, assignment 360 has a set of attributes, which may include characteristics 370 and/or key figures 380. Characteristics 370 may comprise, for example, a name, identification, or account number. Key figures 380 are typically used by businesses to measure performance. Key figures 380 may comprise, for example, a value, currency, price, or other number.

Returning to FIG. 1, assignment creation engine 160 may also create an ACE environment 390 to support assignment creation engine 160. For example, ACE environment 390 may provide background data, such as tables, rules, and/or other particularized information, for ACDs 170.

Table 1 is an exemplary embodiment of a class diagram for ACE environment 390, showing attributes and methods of ACE environment 390.

TABLE 1
ACE Environment

+ID
−Metadata
−Data
−BufferData
+Create(in ID)
+SetMetadata(in Metadata)
+ReadMetadata( )
+SetBuffered(in BufferData)
+GetAttribute(in Business ObjectID, in Selection, in StructureName,
in AttributeName, out Value)
+PrefetchData(in BusinessObjectIDSelection, in OtherKeySelection, in
StructureName)
+FreeBOBuffer( )

A class method of ACE environment 390, referred to herein as a “Create” method, may be called by assignment creation engine 160 to create an instance of ACE environment 390. A class method of ACE environment 390 is a method that is not invoked using a pre-existing instance of ACE environment 390. Each instance of ACE environment 390 may have an attribute, referred to herein as an “ID” attribute, that identifies that particular instance of ACE environment 390. For example, the ID attribute may have the value “ProdOrderOverhead” for a production cost overhead calculation.

ACE environment 390 may use metadata to manage the attribute values in main memory 140 that are available to ACE environment 390. For example, ACE environment 390 may implement the metadata in an attribute, referred to herein as a “Metadata” attribute, that lists a plurality of data structures containing the attributes of the base BOs, such as the master and/or transactional data. The data structures listed in the metadata may contain tables that organize the attributes by a plurality of indices to define value cells. For example, the indices may comprise rows and columns.

The metadata may track attribute values of BOs that were previously stored in main memory 140 by applications 120a, 120b. For example, these attributes may have been loaded into main memory 140 by an online transaction that is still ongoing at the time that assignment creation engine 160 is called. One example, provided for the purpose of illustration, is when assignment creation engine 160 is called to calculate an overhead cost for a production order that is currently being processed in an online change transaction. In this situation, transactional data for actual primary costs may already be loaded in main memory 140 when assignment creation engine 160 is called.

Table 2 shows an exemplary embodiment of an abstract representation of the metadata.

TABLE 2
Metadata

| StructureName | Cardinality | CallbackMethod |
|---|---|---|
| DBTAB1 | 0 . . . 1/0 . . . n | Class Method 1 |
| . . . | . . . | . . . |
| DBTABn | 0 . . . 1/0 . . . n | Class Method n |

The data structures may be individually referred to by a “StructureName” index. For example, the StructureName indices for the ‘n’ number of data structures managed by the metadata of Table 2 are “DBTAB1” through “DBTABn.” A “Cardinality” element may be listed for each of the data structures to indicate how many entries there are for each of the BOs. For example, an individual BO may be associated with one entry (0 . . . 1) or a plural number, ‘n’, of entries (0 . . . n) for that data structure.

The metadata may list one or more elements, referred to herein as “CallbackMethod” elements, that track these already-loaded attributes in main memory 140. Each of the CallbackMethod elements may include a value referring to a “callback” method that can be called by ACE environment 390 to retrieve the requested attribute value from main memory 140. Alternatively, the requested attribute value may not already have been stored in main memory 140 by applications 120a, 120b. In the latter case, there may not be any association between a particular data structure, which has a unique StructureName value, and any CallbackMethod element. If the requested data is not already stored in main memory 140, ACE environment 390 may retrieve the requested data from databases 130a, 130b.

The metadata can be stored as configuration data. For example, the metadata may be stored as configuration data in a system that will be shipped to a customer, in order to pre-configure the system for the customer. The customer may then adapt the configuration data for his specific needs. An instance method of ACE environment 390, referred to herein as a “ReadMetadata” method, may be called to initialize and read the configuration data. An instance method of ACE environment 390 is a method that is invoked using a pre-existing instance of ACE environment 390. In one example, the metadata are stored as a section of a table of the configuration data. The table of the configuration data may be indexed by the ID of ACE environment 390.

Table 3 shows an exemplary embodiment of the configuration data table.

TABLE 3
Configuration Data

| ID | StructureName | Cardinality | CallbackMethod |
|---|---|---|---|
| ProdOrderOverhead | ORDER_HEADER | 0 . . . 1 | CL_OVERHEAD_CALC |
| | | | =>GET_ORDER_HEADER |
| ProdOrderOverhead | ORDER_COSTS | 0 . . . n | |

ACE environment 390 may further provide an instance method, referred to herein as a “SetMetadata” method, that can be called to overwrite the existing metadata. For example, ACE application 150 may call the SetMetadata method to delete the value of one or more of the CallbackMethod elements, such as in the processing of multiple BOs as a batch, which is referred to as a “batch transaction.” The batch transaction may be used to perform a similar or same process on all of the multiple BOs. For each of the multiple BOs processed in the batch transaction, ACE environment 390 may retrieve the requested data from databases 130a, 130b rather than using a callback method to retrieve the data from main memory 140.

ACE environment 390 may also provide a data buffer, implemented in main memory 140, to support assignment creation engine 160 by buffering values of attributes that are anticipated to be requested in the future. These attribute values may not previously have been stored in main memory 140 by applications 120a, 120b such that any corresponding CallbackMethod element is specified. For example, the attributes may be attributes of multiple BOs that are anticipated to be processed in a batch transaction. One example, provided for the purpose of illustration, is when assignment creation engine 160 is called to calculate the effect of a multiple selected projects on profitability in a selected time period. In this situation, relevant attributes associated with all of the selected projects may be loaded into main memory 140 as a batch in anticipation of the calculation to increase processing speed.

ACE environment 390 may include an attribute, referred to herein as a “BufferData” attribute, whose value indicates whether ACE environment 390 should create and use the data buffer. For example, the BufferData attribute may contain a binary flag that specifies whether or not the data buffer should be used. ACE environment 390 may also include an instance method, referred to herein as a “SetBuffered” method, that is called by ACE application 150 to set the value of the BufferData attribute to indicate whether ACE environment 390 should use the data buffer.

In addition, ACE environment 390 may include an attribute, referred to herein as a “Data” attribute, that holds the buffered contents of the data buffer of ACE environment 390. The contents of the data buffer may be indexed by a BO identifier (ID).

An exemplary embodiment of an abstract representation of the Data attribute is shown in Table 4. For each BO ID shown in Table 4, the structures labeled “Structure1 . . . o” are an ‘o’ number of lines, and the structures labeled “Structure1 . . . p” are a ‘p’ number of tables.

TABLE 4
Data

| Business | | |
|---|---|---|
| Object ID | Encapsulated Tables | |
| GUID 1 | Structure1 . . . o | Line1 . . . o type DBTAB1 . . . o |
| | Structure1 . . . p | Table1 . . . p type DBTAB1 . . . p |
| | | . . . |
| | | . . . |
| . . . | . . . | |
| GUID x | Structure1 . . . o | Line1 . . . o type DBTAB1 . . . o |
| | Structure1 . . . p | Table1 . . . p type DBTAB1 . . . p |
| | | . . . |
| | | . . . |

ACE environment 390 may further include an instance method, referred to herein as a “PrefetchData” method, that is called by ACE application 150 to pre-emptively retrieve attribute values from databases 130a, 130b for buffering in main memory 140. The PrefetchData method may receive parameters that include a parameter, referred to herein as a “BusinessObjectIDSelection” parameter, specifying one or more BO IDs that identify the base BOs for the ACE instance, and for which the corresponding ACDs have been assigned. The BusinessObjectIDSelection parameter may even include a table of a plurality of BO IDs.

The PrefetchData method may also receive a parameter, referred to herein as a “StructureName” parameter, that indicates the name of the data structure from which attribute values are to be read for buffering. The attribute values in each of the data structures may be indexed by BO ID. The PrefetchData method may also receive one or more additional parameters, referred to herein as “OtherKeySelection” parameters, to further specify the attributes whose values are to be buffered. The PrefetchData method may be called multiple times, such as one time for each of a plurality of data structures.

The PrefetchData method may create an SQL statement, such as when databases 130a, 130b are SQL databases, that is transmitted to the appropriate one or more of databases 130a, 130b to retrieve the sought attribute values. For example, the SQL statement may have a form that corresponds to the following pseudocode: “Select from (StructureName) into Buffer for all BO IDs in BusinessObjectIDSelection And (OtherKeySelection).”

Table 5 shows an exemplary embodiment of the buffered attribute values after the PrefetchData method has been called.

TABLE 5
Buffered Data

| BO | | | | |
|---|---|---|---|---|
| ID | PlanActualIndicator | FiscalPeriod | AccountNumber | Costs |
| 1 | Actual | 1.2006 | 400000 | 10000, - |
| 1 | Actual | 1.2006 | 410000 | 12323, - |
| 1 | . . . | . . . | . . . | . . . |
| 2 | . . . | . . . | . . . | . . . |

ACE environment 390 may additionally comprise an instance method, referred to herein as a “GetAttribute” method, for obtaining attribute values for evaluation of the functions in ACDs 170. The GetAttribute method may receive parameters that include BusinessObjectID, StructureName, and Attribute. The GetAttribute method may receive additional parameters that serve as further selection keys. The GetAttribute method returns the value of the attribute that is requested by the function, such as within a “Value” attribute. For example, the Value attribute may have a numerical value.

ACE environment 390 may further include an instance method, referred to herein as a “FreeBOBuffer” method, to clear some or all of the attribute values from the data buffer. For example, the FreeBOBuffer method may, after all the ACDs for that BO have been assigned, receive a BO ID to delete the buffered attribute values associated with that BO. By deleting the buffered attribute values when they are no longer needed, the FreeBOBuffer method can continuously reduce memory consumption.

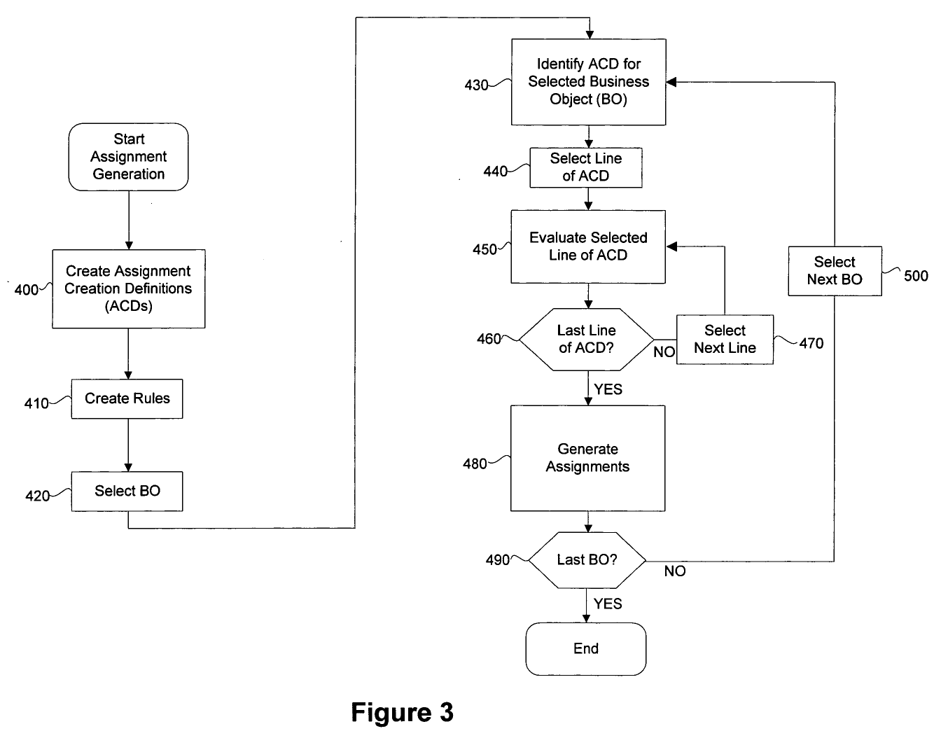

FIG. 3 is a flowchart of an exemplary embodiment, consistent with the present invention, of a method of generating an assignment between each of a base BO and at least one partner BO by creating, assigning, and evaluating an ACD. In FIG. 3, the rectangular boxes represent processes of the method, whereas the hexagonal boxes represent conditional branches of the method.

To enable the automatic creation of assignments, an operator may create one or more ACDs, as shown by step 400. As described above, each ACD contains lines that are executable in relation to a base BO to identify one or more partner BOs and to determine values of one or more attributes of the assignments. Each newly created ACD can be stored for multiple derivation and evaluation steps based on the ACD. The operator may next create the rules that will be used in the derivation process to identify the appropriate ACDs for evaluation, as shown by step 410.

When an application is executed, the application may trigger the ACE to initiate a derivation process that identifies particular ACDs and assigns the ACDs to a plurality of sender and/or receiver BOs. The particular sender and/or receiver BOs may be selected by the application as BOs that should potentially be assigned ACDs. The ACE selects one of those BOs, as shown by step 420, as part of the ACD derivation process. The ACE uses the rules that were previously created to determine which ACD should be assigned to the BO based on the attributes of the BO and the directionality, as shown by step 430.

When an ACD has been assigned to the BO, the BO is referred to as a base BO, and the ACD can be evaluated on a line-by-line basis in preparation for generating the assignments between this base BO and partner BOs. The ACE selects a line of the ACD, as shown by step 440. The selected line is evaluated to determine values of the line, as shown by step 450. For example, one or more functions of the line may be evaluated. If the selected line is not the last line of the ACD, as shown by conditional branch 460, then the evaluation process is repeated for the next line, as shown by step 470. However, if the selected line is the last line of the ACD, then the evaluation process can be terminated.

Based on the results of the evaluation process, assignments are generated between the base BOs and the partner BOs, as shown by step 480. If the line is a generation line, such as a “Cost Center” line, then an assignment is generated for that line. The assignment may include the attribute having the value determined during the evaluation process.

If the BO is not the only remaining BO to be assigned an ACD, as shown by conditional branch 490, then the ACD derivation process is repeated for the next BO to assign an ACD to that BO, as shown by step 500. However, if the BO is the only remaining BO that should potentially be assigned an ACD, then the derivation process is ended, as shown in FIG. 3.

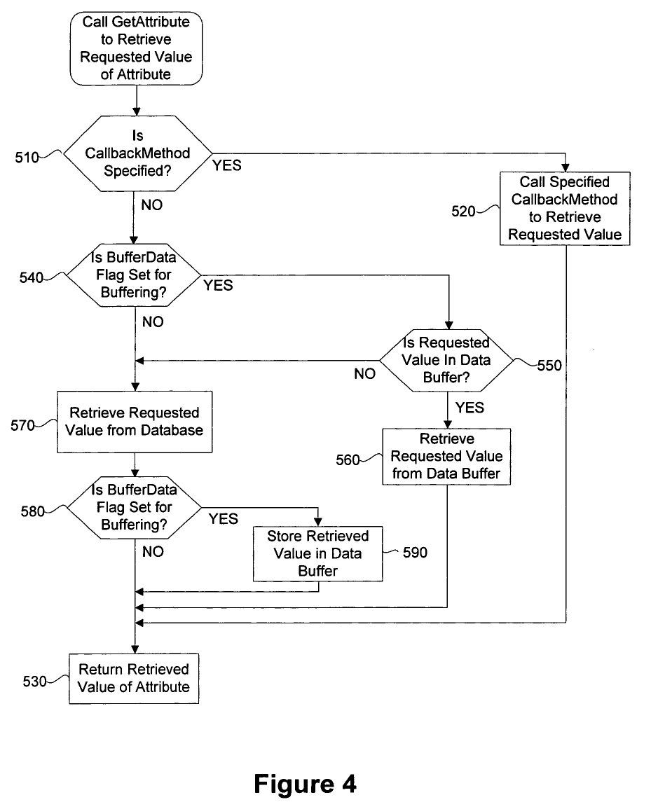

FIG. 4 is a flowchart of an exemplary embodiment, consistent with the present invention, of a method of retrieving a value of an attribute that is requested by a function of an ACD, such as when one of the lines of the ACD is evaluated.

The GetAttribute method is called to retrieve an attribute value that has been requested by the function of the assignment creation definition. The ACE environment determines whether the metadata specifies a value of the CallbackMethod attribute for that particular attribute, as shown by conditional branch 510. If a method is specified as the value of the CallbackMethod attribute, then this method is called to retrieve the requested value from the main memory, as shown by step 520. Thereafter, the ACE environment returns the requested value of the attribute to the assignment creation engine for evaluation of the function of the assignment creation definition, as shown by step 530.

If the CallbackMethod attribute does not specify any method, then the ACE environment determines whether the BufferData attribute, which may include a flag, is set to indicate that the data buffer should be used, as shown by conditional branch 540. If the data buffer should be used, then the ACE environment determines whether the requested value is already stored in the data buffer, as shown by conditional branch 550. If the requested value is determined to be stored in the data buffer, then the ACE environment retrieves the requested value from the data buffer, as shown by step 560. The ACE environment returns the requested value of the attribute to the assignment creation engine for evaluation of the function of the assignment creation definition, as shown by step 530.

If the BufferData attribute is set to indicate that the data buffer should not be used or the requested value is not stored in the data buffer, then the ACE environment retrieves the requested value from the appropriate one or more of the databases, as shown by step 570. If the BufferData attribute indicates that the data buffer should be used, as shown by conditional branch 580, then the ACE environment additionally stores the retrieved value in the data buffer, as shown by step 590. The ACE environment proceeds to return the requested value of the attribute to the assignment creation engine for evaluation of the function of the assignment creation definition, as shown by step 530.

The methods and systems disclosed herein may be embodied in various environments and forms including, for example, a data processor or computer that also includes a database. Moreover, the above-noted features and other aspects and principles of the present invention may be implemented in various environments. Such environments and related applications that are specifically constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programmable instructions written in accordance with teachings of the invention, or it may be more convenient to construct a specialized apparatus to perform the required methods and techniques.

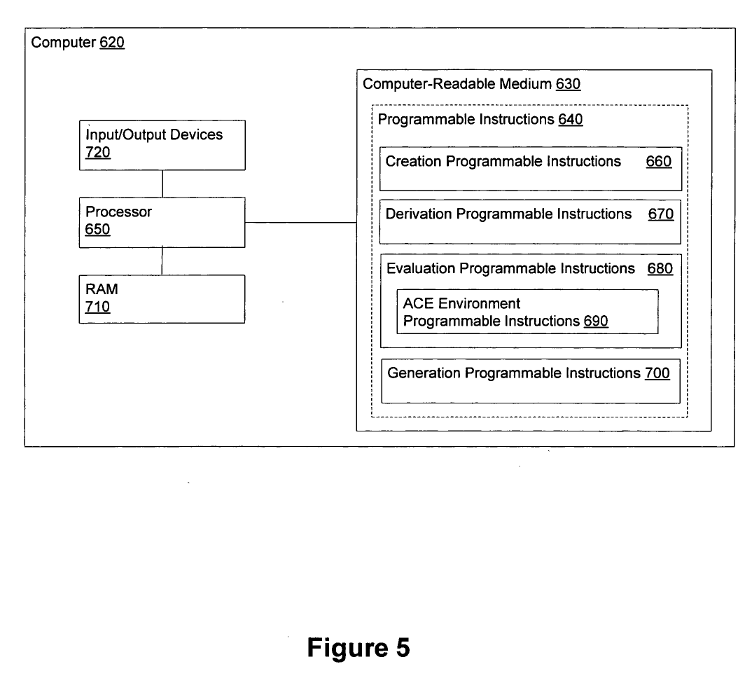

FIG. 5 is a block diagram of an exemplary embodiment, consistent with the present invention, of a computer 620 comprising a computer-readable medium 630 that contains programmable instructions 640, and a processor 650 to execute programmable instructions 640. Programmable instructions 640 may include creation programmable instructions 660 to create ACDs, derivation programmable instructions 670 to assign the ACDs to base BOs upon triggering by an application, and evaluation programmable instructions 680 to evaluate the assigned ACDs to determine partner BOs and values of attributes. In one embodiment, evaluation programmable instructions 680 may include ACE environment programmable instructions 690 to implement the ACE environment, which supports the evaluation of the assigned ACDs. Programmable instructions 640 may further include generation programmable instructions 700 to generate assignments, having the attributes, between the base BOs and the partner BOs. Computer 620 may comprise a RAM 710, such as a solid-state RAM, to temporarily store data. Input/output devices 720 may also be provided to communicate with external devices and/or a human operator.

The databases, which implements the databases containing the master and transactional data of the BOs, and/or the main memory may be implemented in computer 620. For example, the databases may be implemented in computer-readable medium 630. The main memory may be implemented in, for example, RAM 700. Alternatively or in addition, the database memory and/or the main memory may be implemented in one or more separate computer-readable media.

Computer 620 of FIG. 5 is provided only to illustrate an exemplary embodiment of the invention and, thus, should not be used to limit the scope of the invention or its equivalents. For example, computer 620 may be distributed across a plurality of physically separate computers that are communicatively coupled to one another. Computer-readable medium 630 and/or RAM 700 may also be distributed across a plurality of physically separate computer-readable media.

The methods, systems, and computer-readable media described herein may improve the efficiency of evaluating ACDs for particular BOs to generate assignments linked to those BOs. For example, the speed of evaluation can be increased by managing pre-loaded attribute values. The speed of evaluation can also be increased by storing values of attributes that are anticipated to be requested in a data buffer. Furthermore, consumption of memory resources can be decreased by managing the storage of the attribute values in the data buffer.

The foregoing description of possible implementations and embodiments consistent with the present invention does not represent a comprehensive list of all such implementations or all variations of the implementations described. The description of only some implementations should not be construed as an intent to exclude other implementations or embodiments. One of ordinary skill in the art will understand how to implement the invention in the appended claims in other ways, using equivalents and alternatives that do not depart from the scope of the following claims.

What is claimed is:

1. A method of handling attributes to generate an assignment between a base business object and a partner business object in a value flow environment, the method comprising:
reading a function of an assignment creation definition to identify an attribute of the base business object, a value of the attribute being required for evaluation of the function;
determining whether the value of the attribute is stored in a main memory;
if the value of the attribute is stored in the main memory, then retrieving the value from the main memory;
if the value of the attribute is not stored in the main memory, then retrieving the value from a database; and
evaluating the function based on the retrieved value of the attribute to generate the assignment.

2. The method of claim 1, wherein determining whether the value of the attribute is stored in the main memory comprises determining whether a callback method is associated with an identifier of a data structure containing the value, and wherein retrieving the value from the main memory comprises calling the callback method.

3. The method of claim 1, wherein determining whether the value of the attribute is stored in the main memory comprises determining whether a data buffer in the main memory is being used, and wherein retrieving the value from the main memory comprises retrieving the value from the data buffer.

4. The method of claim 1, wherein reading the value from the database comprises requesting the value based on (i) an identifier of a data structure in the database, (ii) an identifier of the base business object, and (iii) an identifier of the attribute.

5. The method of claim 1, wherein the main memory comprises a data buffer, and, if the value has been retrieved from the database, then further comprising storing the value in the data buffer.

6. The method of claim 1, wherein the main memory has a first access speed and the database has a second access speed, the first access speed being greater than the second access speed.

7. The method of claim 1, further comprising (i) determining whether a callback method is associated with the identifier of the data structure and, if there is not any callback method associated with the identifier, then (ii) determining whether a data buffer is being used and, if the data buffer is being used, then (iii) searching the data buffer for the attribute.

8. The method of claim 1, further comprising selectively clearing the value of the attribute from the main memory.

9. The method of claim 1, wherein the line is a non-generation line to supply one or more values to a generation line that subsequently performs the generation of the assignment.

10. A system for handling attributes to generate an assignment between a base business object and a partner business object in a value flow environment, the system comprising:
a main memory;
a database; and
an evaluator, the evaluator being adapted to:
read a function of an assignment creation definition to identify an attribute of the base business object, a value of the attribute being required for evaluation of function,
determine whether the value of the attribute is stored in the main memory,
if the value of the attribute is stored in the main memory, then retrieve the value from the main memory,
if the value of the attribute is not stored in the main memory, then retrieve the value from the database, and
evaluate the function based on the retrieved value of the attribute to generate the assignment.

11. The system of claim 10, wherein the evaluator determines whether the value of the attribute is stored in the main memory by determining whether a callback method is associated with an identifier of a data structure containing the value, and wherein the evaluator retrieves the value from the main memory by calling the callback method.

12. The system of claim 10, wherein the evaluator determines whether the value of the attribute is stored in the main memory by determining whether a data buffer in the main memory is being used, and wherein the evaluator retrieves the value from the main memory by retrieving the value from the data buffer.

13. The system of claim 10, wherein the evaluator reads the value from the database by requesting the value based on (i) an identifier of a data structure in the database, (ii) an identifier of the base business object, and (iii) an identifier of the attribute.

14. The system of claim 10, wherein the main memory comprises a data buffer, and, if the value has been retrieved from the database, then the evaluator stores the value in the data buffer.

15. The system of claim 10, wherein the main memory has a first access speed and the database has a second access speed, the first access speed being greater than the second access speed.

16. The system of claim 10, wherein the evaluator (i) determines whether a callback method is associated with the identifier of the data structure and, if there is not any callback method associated with the identifier, then (ii) determines whether a data buffer is being used and, if the data buffer is being used, then (iii) searches the data buffer for the attribute.

17. The system of claim 10, wherein the evaluator selectively clears the value of the attribute from the main memory.

18. The system of claim 10, wherein the line is a non-generation line to supply one or more values to a generation line that subsequently performs the generation of the assignment.

19. A computer-readable medium comprising programmable instructions adapted to perform a method of handling attributes to generate an assignment between a base business object and a partner business object in a value flow environment, the method comprising:
reading a function of an assignment creation definition to identify an attribute of the base business object, a value of the attribute being required for evaluation of the function;
determining whether the value of the attribute is stored in a main memory;
if the value of the attribute is stored in the first memory, then retrieving the value from the main memory;
if the value of the attribute is not stored in the first memory, then retrieving the value from a database; and
evaluating the function based on the retrieved value of the attribute to generate the assignment.

20. The computer-readable medium of claim 19, wherein determining whether the value of the attribute is stored in the main memory comprises determining whether a callback method is associated with an identifier of a data structure containing the value, and wherein retrieving the value from the main memory comprises calling the callback method.

21. The computer-readable medium of claim 19, wherein determining whether the value of the attribute is stored in the main memory comprises determining whether a data buffer in the main memory is being used, and wherein retrieving the value from the main memory comprises retrieving the value from the data buffer.

22. The computer-readable medium of claim 19, wherein reading the value from the database comprises requesting the value based on (i) an identifier of a data structure in the database, (ii) an identifier of the base business object, and (iii) an identifier of the attribute.

23. The computer-readable medium of claim 19, wherein the main memory comprises a data buffer, and, if the value has been retrieved from the database, then further comprising storing the value in the data buffer.

24. The computer-readable medium of claim 19, wherein the main memory has a first access speed and the database has a second access speed, the first access speed being greater than the second access speed.

25. The computer-readable medium of claim 19, wherein the method comprises (i) determining whether a callback method is associated with the identifier of the data structure and, if there is not any callback method associated with the identifier, then (ii) determining whether a data buffer is being used and, if the data buffer is being used, then (iii) searching the data buffer for the attribute.

26. The computer-readable medium of claim 19, wherein the method further comprises selectively clearing the value of the attribute from the main memory.

27. The computer-readable medium of claim 19, wherein the line is a non-generation line to supply one or more values to a generation line that subsequently performs the generation of the assignment.
